(19) United States
(12) Patent Application Publication
(10) Pub. No.: US 2006/0164248 A1
(43) Pub. Date: Jul. 27, 2006

(54) Backscatter transponder modulated in an energetically self-sufficient manner

(75) Inventor: Martin Vossiek, Hildesheim (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/526,116

(22) PCT Filed: Aug. 4, 2003
(86) PCT No.: PCT/DE03/02613

§ 371 Date: Feb. 28, 2005

(30) Foreign Application Priority Data
Aug. 27, 2002 (DE) 102 39 303.6

(51) Int. Cl. G08B 13/14

(52) U.S. Cl. 340/572.7; 340/10.1

(57) ABSTRACT

Disclosed is a device comprising a converter (EW) which converts ambient energy into an alternating quantity (WSig) and a reflector (MR) that can be modulated via the alternating quantity.

Sensors generally have an electrical cable connection via which the sensors are supplied with energy and over which the measured quantities of the sensor are transferred electrically. The cable is often unwanted since it generates costs from installation, material and maintenance. Furthermore the cable makes it more difficult or impossible to fit sensors to rotating or moving parts under harsh environmental conditions (heat, danger of explosion, high tension, in a vacuum etc.) and in difficult-to-reach places.

In option for avoiding using the cable to transfer sensor data is to transmit the measurement data by radio from the measurement location to a remote evaluation unit. These previously known radio sensors have one significant disadvantage however: They need a battery or similar energy source which entails significant procurement and particularly maintenance costs. The use or lifetime of the battery will frequently also be limited by the environmental conditions (e.g. very high or low temperatures).

Furthermore the principle of modulated backscatter for radio data transmission using the name backscatter or also backscatter transponder is known for example from M. Kossel, H. R. Benedickter, R. Peter, W. Bachtold: “MICROWAVE BACKSCATTER MODULATION system”, 2000 IEEE MTT-S International Microwave Symposium, Boston, Mass., USA, 11-16 June 2000, Volume 3, pages 1427-30. Related devices are described in documents such as EP 646983 A2, EP 712010 A1 EP 853245 A2, EP 899682 A2, US 20010000430 A1, U.S. Pat. No. 6,107,910 A1, U.S. Pat. No. 6,236,314 B1 and WO 1999008402 A1.

In addition, in DE 10025561 A1 an energetically self-sufficient high-frequency transmitter is described in which mechanical energy is converted into electrical energy in an electromechanical converter, rectified and fed under the control of a logic module to a high-frequency transmission stage.

Using this as its starting point, the object of the invention is to develop an energetically self-sufficient high-frequency transmitter which is extremely low-cost and can be produced in large quantities.

This object is achieved by the inventions of the independent claims. Advantageous embodiments are specified in the subclaims.

The invention is based on two fundamental ideas. The first consists of separating the generation of the energy for the information to by transmitted by the energetically self-sufficient high-frequency transmitter and the generation of the energy which is needed for the transmission process itself. Starting with the knowledge that in the minimum case only the energy for the information to be transmitted is to be generated, it is possible to dispense with generating the energy for the transmission process itself and with the components required for this.

This knowledge follows on from numerous considerations as to how a minimum component configuration for an energetically self-sufficient high-frequency transmitter can appear. This considerations finally reached their peak in the astonishing idea of using an alternating quantity created by a converter directly and without buffering for modulating the signal of the high-frequency transmitter. This enables the rectifier circuits or components with non-linear characteristics needed in the prior art, which are usually needed to accumulate alternating energy, to be dispensed with. As a result it is also possible to dispense with those components which would be needed to store the energy.

If the alternating quantity is finally used for modulation of a reflector, the energy generation for the transmission process itself can be dispensed with by utilizing the energy of an interrogation signal.

Accordingly the device features a converter to convert ambient energy into an alternating quantity and a reflector which can be modulated by the alternating quantity.

To operate the device, which transmits its state its change of state by radio, ambient energy from the environment of the converter as a locally-available energy (that is available at the device location or in its immediate vicinity) is used. This energy can be thermal energy, acoustic energy, mechanical or electrical or electromagnetic energy. The requirement is that the available energy or the quantities derived or converted from it, which are used as shown below for measurement and/or for radio data transmission of a measured quantity, is an alternating quantity. In particular the alternating quantity is an alternating voltage and/or an alternating current.

The outstanding feature of the principle in accordance with the invention is thus that the alternating quantity derived from the locally available energy is used to modulate a radio wave reflector in its reflection characteristics, especially its reflection factor.

The reflector is preferably a reflector for an electromagnetic signal, especially for a high-frequency signal. This radio wave reflector can be radiated from a distance from a base station with a radio signal. This radio signal preferably lies in the frequency range 100 kHz to 100 GHz. The signal sent by the base station is reflected at the radio wave reflector. To this end the device preferably features an antenna. The device thereby forms an energetically self-sufficient backscatter transponder.

Since the reflector is modulated by said alternating quantity in its reflection factor, a modulation is impressed on the signal reflected at the radio wave reflector. The base station receives the modulated reflection signal of the sensor and evaluates it. The modulation makes the reflected signal very easy to distinguish from other fixed reflections, which are for example produced by objects which are in the capture area of sensor.

Preferably the device is set up to measure a measured quantity in the form of a sensor value to be measured.

The measured quantity can in the simplest case be the alternating quantity, that is in the radio signal the modulation itself. The converter then converts the ambient energy as a function of the measured quantity into the alternating quantity, so that the measured quantity can be measured via the modulation of the reflector.

Alternatively or additionally, in a somewhat more complicated embodiment of the principle the alternating quantity can however also be influenced by the measured quantity or by a further measured quantity in a characteristic way. To this end the device features means for influencing the alternating quantity as a function of a measured quantity, so that the measured quantity is measurable via the modulation of the reflector. These means are especially arranged in or on a supply lead which feeds the alternating quantity to the reflector. Suitable means are for example state-dependent passive filters or attenuation elements or state-dependent energy converters which characteristically influence or prespecify the alternating signal and thereby the modulation depending on the measured quantity.

The energy for modulating the backscattering for sensor purposes is obtained from the energy of the measured quantity or from energy events accompanying the change of measured quantity and this forms a self-sufficient remotely-readable sensor. The transmit and receive part of the base station and the signals used can in principle be designed identically to normal backscatter systems.

An inventive method is produced in a similar way to the device. This also applies for its preferred developments.

Further major advantages and features of the invention are produced from the description of an exemplary embodiment with reference to the figures. The Figures show:

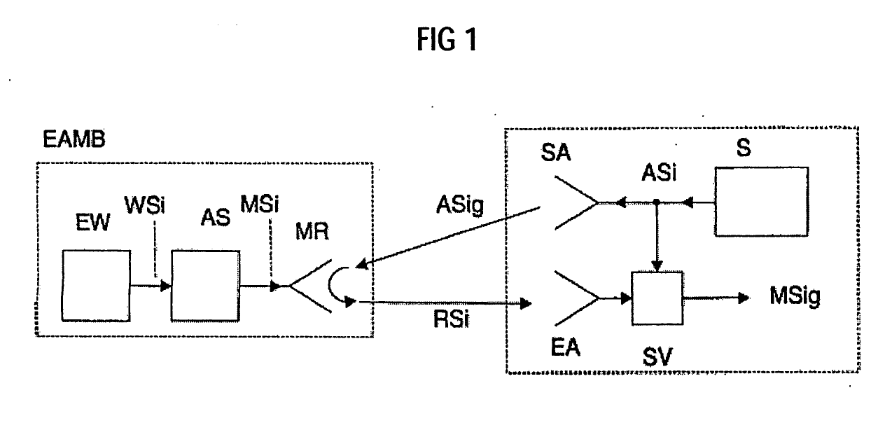

FIG. 1 the basic structure of an energetically self-sufficient modulated backscatter transponder and an energetically self-sufficient remotely-pollable radio sensor,

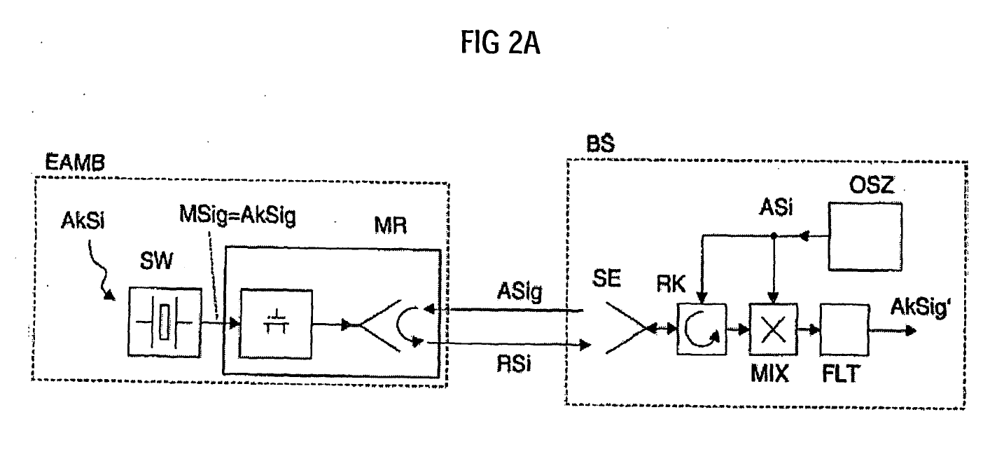

FIG. 2a a possible embodiment of an energetically self-sufficient modulated backscatter transponder in the form of an energetically self-sufficient remotely-pollable structure-borne sound sensor,

FIG. 2b a concrete circuit technology solution for the energetically self-sufficient modulated backscatter transponder from FIG. 2a,

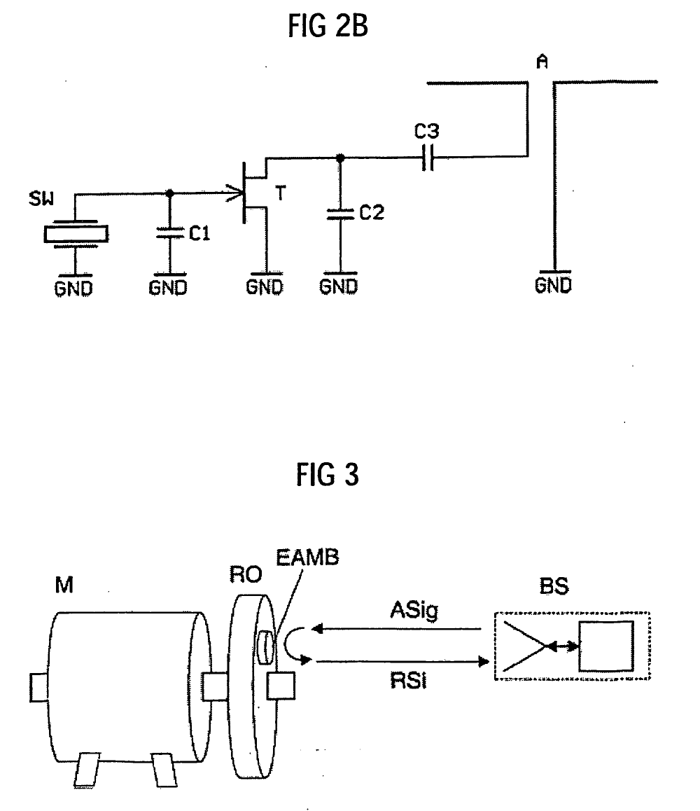

FIG. 3 a possible application of the energetically self-sufficient remotely-pollable structure-borne sound sensor from FIG. 2a,

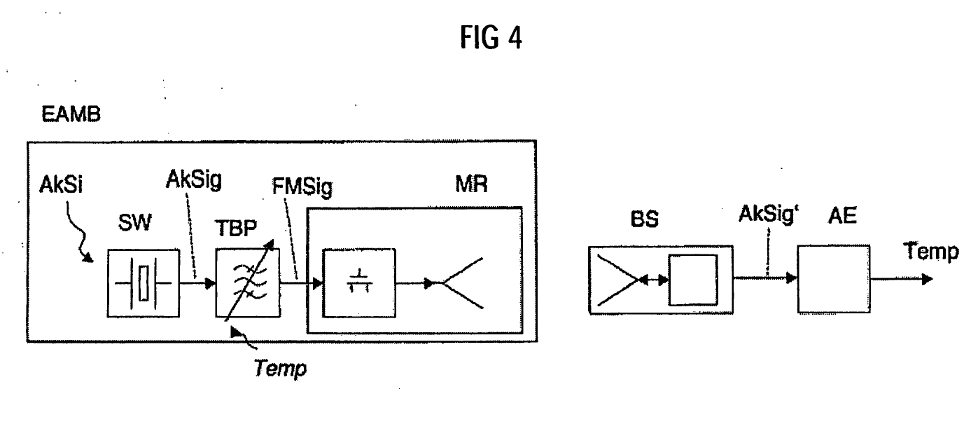

FIG. 4 a possible embodiment of an energetically self-sufficient modulated backscatter transponder as a temperature sensor,

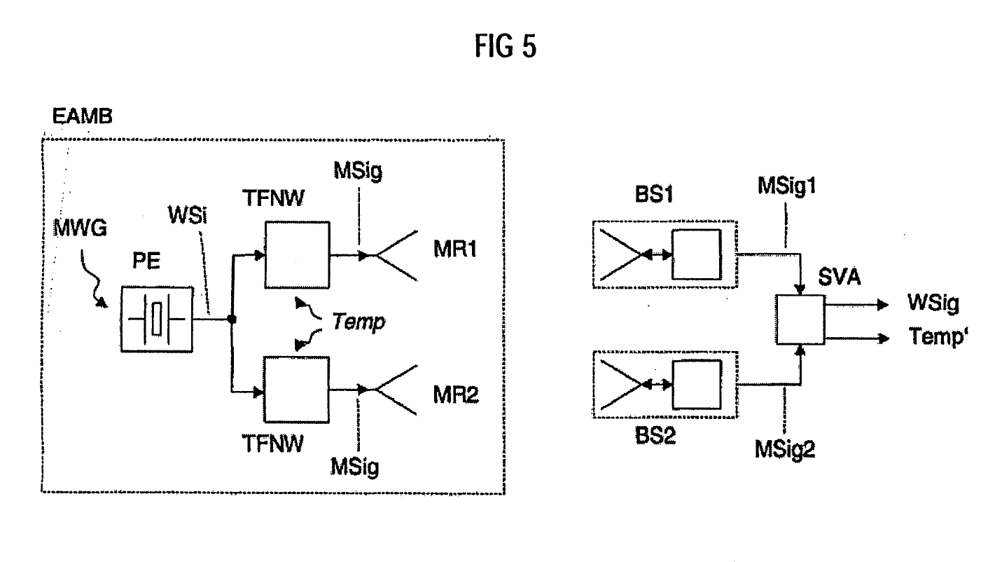

FIG. 5 an embodiment with two paths.

FIG. 1 shows basic structure of an energetically self-sufficient modulated backscatter transponder and an energetically self-sufficient remotely-pollable radio sensor. The backscatter transponder modulated in an energetically self-sufficient manner EAMBT includes at least the following components. With the energy converter EW available ambient energy in the form of an alternating energy quantity is converted into an electrical alternating quality or an alternating signal WSig.

Optionally this alternating signal will also be adapted with an adaptor circuit such that the resulting modulation signal MSig is particularly well suited for modulation of the modulatable reflector MR. The original alternating quantity in the form of an alternating signal is in this case thus converted into a derived alternating quantity in the form of a modulation signal.

In particular it can be useful for this adapter circuit to include a transformer. The modulatable reflector can for example be an antenna for which adaptation is varied at its input or output with the modulation signal MSig. Depending on its adaptation, the antenna reflects a radio signal which it receives more or less strongly (amplitude modulation) or reflects it with a more or less large phase offset (phase modulation) or reflects as a function of modulation signal MSig at different strengths for different frequencies (frequency modulation). This effect of modulated reflection is used in a further development to interrogate the backscatter transponder EAMBT remotely by radio with a base station BS.

To this end the base station contains at least one signal source S, with which the interrogation signal ASig is generated and emitted over a transmit antenna as radio signal Asig′ in the direction of the backscatter transponder EAMBT. This signal is reflected at the backscatter transponder EAMBT. The radio signal RSig reflected in this way is received via a receive antenna and compared using a signal comparator SV with the transmitted interrogation signal ASig. Apart from a small delay because of the route from the base station to the backscatter transponder EAMBT and back again and when necessary impressed noise signals, the interrogation signal ASig and the reflected radio signal RSig only differ in the modulation which was impressed onto the reflected radio signal radio signal RSig by the backscatter transponder EAMBT. The comparison of interrogation signal ASig and reflected radio signal RSig thus enables an image MSig′ of the modulation signal MSig to be formed directly in the base station and thereby the energy alternating quantity belonging to the measured quantity to be measured remotely by radio energetically self-sufficiently.

The energetically self-sufficient modulated backscatter transponder and an energetically self-sufficient remotely-pollable radio sensor can be embodied in numerous forms.

FIG. 2a shows a simple version as energetically self-sufficient remotely-pollable structure-borne sound sensor. The energy converter in this case is a sound converter, preferably a piezo electric sound or ultrasound converter. If this receives an acoustic signal AkSig it converts it into a electrical signal. This electrical modulation signal MSig=AKSig′, which is used below for modulation of the modulatable reflector, is in principle an image of the acoustic signal. The modulatable reflector preferably comprises a field effect transistor with which the adaptation of its antenna, as already indicated above, is varied. Preferably those types of field effect transistor are used for this purpose which can also be modulated around the operating value OV, i.e. without additional prevoltage. FIG. 2b shows a typical simple embodiment. The voltage that the piezo sound converter SW generates modulates the gate of the field effect transistor and thereby the admittance of the drain-source path. The capacitors C2 and C3 are used for adaptation of antenna A. The circuit illustrates a decisive advantage of the solution in accordance with the invention, namely that it can be implemented especially simply and cheaply.

Suitable types of field effect transistor for the circuit shown here might typically be the types SST310 from Vishay or maybe MGF4953A from Mitsubishi.

As well as field effect transistors, all other components would naturally also be suitable which change their admittance or the reflection or transmission function depending on an applied voltage. Suitable components might typically be transistors, diodes, varactors, controllable dielectrics, micromechanical switches or phase shifters (MEMs) etc.

The base station BS contains a fixed-frequency oscillator OSZ which generates the interrogation signal ASig. The interrogation signal is emitted via the combined transmit/receive antenna SEA in this embodiment. The transmit/receive antenna SEA is also used to receive the modulated reflected signal RSig. The directional coupler RK is used to separate the transmit and receive signal. The signal comparison already described for FIG. 1 is undertaken here by a mixer, i.e. the transmit signal ASig is mixed with the reflected signal RSig and preferably subsequently filtered with a filter FLT. The filter FLT is preferably embodied as a bandpass or lowpass filter. The limit frequencies of FLT are preferably to be selected so that they correspond to the frequency range of interest for acoustic signal AkSig or those of modulation signal MSig. Through the mixer arrangement shown the modulation i.e. in principle the modulation signal MSig is separated from the carrier, i.e. in principle ASig. At the output of the filter FLT one can thus tap off and present or process an image AkSig″ of AkSig′ or AkSig.

In the embodiment shown here of the base station the basic principles involved are a normal continuous wave or Doppler radar. All known embodiments of such systems can thus be directly transferred to the inventive solution. The possibility of modulating the reflection factor or adapting an antenna via a field effect transistor are also present in numerous forms in the prior art. Known circuits are thus easy to transfer to the solution in accordance with the invention. Concrete embodiments are thus no longer presented here of these components since they are known to experts as such or can be looked up in the relevant literature. The energetically self-sufficient remotely-pollable structure-borne noise sensor shown is for example, as depicted in FIG. 3, suitable for measurement and supervision of structure-born noise and vibration processes on rotating parts.

Typical components which could be equally well monitored with an EAMBT are elements of motor vehicles, drives and machines with wheels, axles, springing elements, bearings, components of the bearings such as roller bearings or thrust rings, ventilation and turbine blades, cylinders, gearwheels, belts etc.

It should be pointed out particularly at this point that, with a more complicated embodiment of the base station it is also possible is to determine the distance to a backscatter transponder with modulated reflection. Embodiments which can be transferred to an energetically self-sufficient modulated backscatter transponder EAMBT can be found in M. Vossiek, R. Roskosch, and P. Heide:“Precise 3-D object position Tracking using FMCW Radar”, 29th European Microwave Conference, Munich, Germany, 1999, and in the documents DE 19957536 A1, DE 19957557 A1 and especially in the 19946161 A1.

As an alternative to the sound sensor presented, other converter principles can naturally also be employed in what is otherwise the same arrangement to measure other variables. Suitable candidates would for example be pyroelectric converters, photoelectric converters, piezoelectric pressure or bending converters or also widely used generator principles with magnet and coil.

The frequencies used a interrogation signal of the base station will preferably be those which are also otherwise useful and normal for transponder systems, that is for example 125 kHz, 250 kHz, 13.7 MHz, 433 MHz, 869 MHz, 2.45 GHz or 5.8 GHz. It is useful for the frequency of the interrogation signal to be selected so that it is far greater than—e.g. by the factor of 10—the frequency of the alternating quantity WSig, since then in the base station the carrier, that is the interrogation signal, can be separated with simple means from the modulation, i.e. WSig.

Based on the previous embodiments, very many developments of sensor and identification systems can also be implemented however. The basic idea here lies in the fact that the alternating signal generated by the converter can now no longer include the exclusive sensor information itself but that this signal is characteristically changed in its properties by a further effect or a further measured quantity and from the size of the change in the base station the measured quantity can be derived. The characteristic change could naturally also be initiated deliberately and in a defined way in the sense of an encoding, with the aim of enabling objects to be identified.

The basic idea of the developed embodiment is illustrated using the simple design in FIG. 4. In principle this is the same embodiment as in FIG. 2. The difference lies in the fact that the electrical alternating quantity AkSig′ is now not used directly for modulation of the modulatable reflector MR but is filtered beforehand, e.g. by a temperature-dependent bandpass filter TBPF characteristically depending on the temperature. The tuning of the filter can easily be realized by temperature-dependent resistors or similar.

Assuming the frequencies of the acoustic signal are practically equally distributed over a longer observation period over the tuning range of the TBPF or the distribution is approximately known, the spectral power density distribution or values derived from it such as the focus or the maximum of the spectrum of AkSig″ are a direct measure of the temperature. For example these values could be easily derived by a Fourier transformation of AkSig″ in an evaluation unit AE.

As well as filtering, other influences on alternating value WSig conditioned by measured quantities for encoding the measured value are naturally also conceivable. Timers, phase shifters, attenuation elements would also be suitable for example. If filters are used, resonator filters with a bandpass or band blocking characteristics are particularly suitable since on the one hand their influence on the signal characteristics can be evaluated with simple resources and on the other hand they can be easily realized. It would also be conceivable for the converter itself to be characteristically changed by a physical or chemical value in its conversion characteristics, i.e. that for example the frequency of a sound converter is temperature-dependent or dependent on mechanical general conditions such as pressure and voltage.

Not only temperature sensors but in a similar way pressure sensors, moisture sensors or chemical, energetically self-sufficient remotely-pollable sensors could also be implemented in this way. In principal each passive sensor element is suitable with which the modulation signal MSig can be changed in a characteristic way. Naturally the modulation signal MSig does not also exclusively have to serve as carrier for the sensor information but it can also, as has already been shown above, also carry sensor information itself.

In the diagram of the embodiment shown in FIG. 4 it was assumed that the property such as for example the spectral distribution of the alternating value WSig is known. However it is not always possible to make this assumption. Consequently it is not always possible would have a version as simple as the one shown in FIG. 4 to determine exact measurement data or to transfer it. FIG. 5 shows a version which solves this problem.

This diagram indicates that the alternating quantity WSig is derived for example by a piezo element PE from a mechanical alternating quantity. Of importance for the version is that the alternating signal WSig is split into at least two paths and further processing differs on these paths. To implement a temperature sensor the backscatter transponder EAMBT can for example feature in one path a temperature-dependent filter network TFNW1 or TFNW2. These filter networks can for example, as has already been described, be embodied as frequency-determining for authors, delay time elements, phase shifters or attenuation elements.

The decisive factor is that the influence that the TFNW1 and TFNW2 exercise on the alternating quantity WSig are dependent in a characteristic way differently from the measured value—that is here the temperature Temp. The resulting differently influenced modulation signals MSig1 and MSig2 are then transmitted in accordance with the previously described interrogation principle on separate channels, e.g. over separate frequency bands to separate base stations BS1 and BS2 and are reconstructed there, as previously shown, as signals Msig1′ and MSig2′. The signal comparison and evaluation unit SVAE can then, based on the known characteristics of the filter networks TFNW1 and TFNW2, derive the measured temperature value Temp and/or an image of the alternating quantity WSig.

Preferably the signal comparison and evaluation unit SVAE includes a processor for this purpose. The basic idea of the version is thus no longer to deride the measured value directly from absolute characteristic values of the signal but from a relative comparison between at least two signals MSig1′ and MSig2′. This enables much better prevention of the possible disturbance by alternating and unknown characteristics of the alternating quantity WSig to the evaluation and the derivation of the measured value.

If the filter networks TFNW1 and TFNW2 are designed as temperature-dependent delay elements for example, with the delay difference between the two signal parts changing characteristically with the temperature, then for example the delay time difference of the signals MSig1 and MSig2′ which then represents a measure of the temperature, can easily be determined with the aid of a cross correlation between MSig′ and MSig2′. The position of the maximum of the cross correlation would for example be a measure of the temperature here. With use of temperature-dependent phase shift elements in TFNW1 and TFNW2 a simple analog or digital phase comparator could also perform a comparable function.

The version shown represents only one possible variant. As has already been illustrated above other measured quantities can naturally also be determined in the same way. It would also be conceivable to perform the separation into at least two paths not just in the level of the measured quantity-dependent filler networks but to simultaneously use at least two separate energy converters.

1-11. (canceled)

12. A device of a energetically self-sufficient transponder, comprising:
a converter for converting ambient energy into an alternating quantity and into energy for modulation of a reflector configured to be modulated via the alternating quantity.

13. The device according to claim 12, wherein said reflector is a reflector for an electromagnetic signal.

14. The device according to claim 13, wherein said reflector is a reflector for a high-frequency signal.

15. The device according to claim 12, which further comprises an antenna connected to said converter.

16. The device according to claim 12, wherein the device is configured as a backscatter transponder.

17. The device according to claim 12, wherein the device is configured to measure a measured quantity.

18. The device according to claim 17, wherein said converter is configured to convert the ambient energy into the alternating quantity in dependence on the measured quantity.

19. The device according to claim 18, which further comprises means for influencing the alternating quantity as a function of the measured quantity.

20. The device according to claim 17, which further comprises means for influencing the alternating quantity as a function of the measured quantity.

21. The device according to claim 12, which comprises means for generating a first alternating quantity and a second alternating quantity.

22. The device according to claim 21, wherein the first alternating quantity and the second alternating quantity are derived alternating quantities, generated by splitting an original alternating quantity into the first alternating quantity and the second alternating quantity, and wherein, subsequent to splitting, the first alternating quantity and the second alternating quantity are separately and differently influencable by a measured quantity.

23. The device according to claim 21, wherein said converter is a first converter for generating a first alternating quantity, and which further comprises a second converter for generating the second alternating quantity.

24. A method, which comprises:
converting, with an energetically self-sufficient transponder having a converter, ambient energy into an alternating quantity and into energy for modulation of a reflector; and
modulating the reflector via the alternating quantity.
